(19) United States
(12) Patent Application Publication
(10) Pub. No.: US 2009/0327410 A1
(43) Pub. Date: Dec. 31, 2009

(54) WEB PAGE DATA TRANSMITTING APPARATUS AND METHOD OF CONTROLLING OPERATION OF SAME

(76) Inventor: Takashi MIYAMOTO, Tokyo (JP)

Correspondence Address: BIRCH STEWART KOLASCH & BIRCH, PO BOX 747, FALLS CHURCH, VA, 22040-0747, US

(21) Appl. No.: 12/487,987

(22) Filed: Jun. 19, 2009

(30) Foreign Application Priority Data
Jun. 20, 2008 (JP) 2008-161089

(51) Int. Cl. G06F 15/16

(52) U.S. Cl. 709/203

(57) ABSTRACT

If a request for a web page is one based upon a crawler, HTML data is transmitted instead of multimedia data. In order to achieve this, if the request is one for a web page represented by multimedia data, it is determined whether the request is one based upon a crawler. If the request is based upon a crawler, then XML data is converted to HTML data by crawler script. The HTML data obtained by the conversion is then transmitted to the terminal that issued the request.

### BACKGROUND OF THE INVENTION

1. Field of the Invention

This invention relates to an apparatus for transmitting web page data and to a method of controlling the operation of this apparatus.

2. Description of the Related Art

In order to prevent amount of content from becoming too excessive, a technique for reducing content has been disclosed (see the specification of Japanese Patent Application Laid-Open No. 2005-286560).

In order to create the search database of a search engine, software referred to as a “crawler” is utilized to collect web pages from the world over, and what is contained in these web pages is analyzed. There are instances where a web page includes content controlled by software that not only simply pastes text and images but that also creates web content by combining images and audio, etc. In the case of a web page that includes content controlled by such software, there are instances where the contents of the web page cannot be analyzed by a crawler.

### SUMMARY OF THE INVENTION

Accordingly, an object of the present invention is to so arrange it that the contents of a web page can be analyzed by a crawler.

According to the present invention, the foregoing object is attained by providing a web page data transmitting apparatus comprising: a web page request receiving device for receiving a request for a web page that includes content controlled by software for creating web content by combining images and audio; a determination device (determination means) for determining whether transmission of the request received by the web page request receiving device is based upon a crawler; a converting device (converting means), responsive to a determination by the determination device that the transmission of the request is based upon a crawler, for converting a description of the web page specified by the request received by the web page request receiving device from one controlled by the software for creating the web content to one based upon HTML; and a transmitting device for transmitting data, which represents the web page converted by the converting device to the description that is based upon HTML, to a terminal device that issued the request.

The present invention also provides a method of controlling operation suited to the above-described web page data transmitting apparatus. Specifically, the method comprises the steps of: receiving a request for a web page that includes content controlled by software for creating web content by combining images and audio; a determining whether transmission of the request received by the web page request receiving device is based upon a crawler; in response to a determination that the transmission of the request is based upon a crawler, converting a description of the web page specified by the received request from one controlled by the software for creating the web content to one based upon HTML; and transmitting data, which represents the web page converted by the converting device to the description that is based upon HTML, to a terminal device that issued the request.

The present invention also provides a program executed by a computer processor for controlling the above-described web page data transmitting apparatus.

In accordance with the present invention, a request for a web page that includes content controlled by software for creating web content by combining images and audio is received, whereupon it is determined whether transmission of this request is based upon a crawler. If it is determined that transmission is based upon a crawler, the description of the requested web page is converted from that controlled by the software for creating the web content to that based upon HTML (HyperText Markup Language). The data representing the web page obtained by the conversion is transmitted to the terminal device that issued the request.

If, when there is a request for a crawler-based web page, the web page includes content controlled by software for creating web content, the description of the requested web page is converted from a description controlled by the software for creating web content to a description that is based upon HTML. The web page data based upon HTML is transmitted to the terminal device that transmitted the request. As a result, a crawler can analyze the contents of the web page.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a system for transmitting web page data;

FIG. 2 illustrates an example of a web page represented by multimedia data;

FIG. 3 illustrates an example of XML data;

FIG. 4 illustrates an example of script for a crawler;

FIG. 5 illustrates an example of HTML data;

FIG. 6 illustrates an example of a template;

FIG. 7 illustrates an example of script for general use; and

FIG. 8 is a flowchart illustrating processing executed by a web server.

### DESCRIPTION OF THE PREFERRED EMBODIMENT

A preferred embodiment of the present invention will now be described in detail with reference to the drawings.

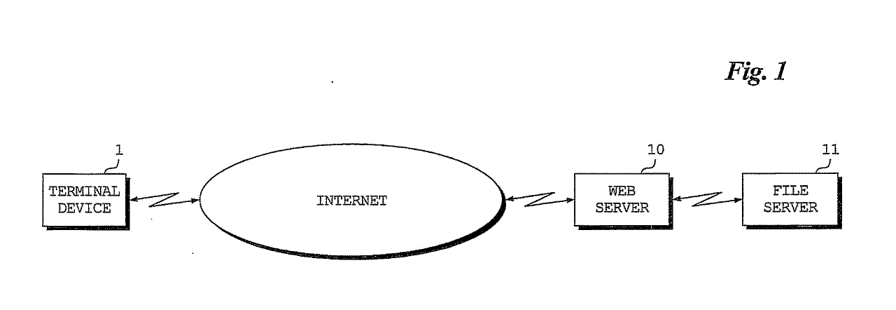

FIG. 1 illustrates an overview of a web page data transmitting system according to an embodiment of the present invention.

The web page data transmitting system includes a terminal device 1 and a web server 10 that are capable of communicating with each other over the Internet. The web server 10 is capable of communicating with a file server 11. It may be so arranged that communication between the web server 10 and file server 11 also is performed using the Internet.

The terminal device 1 is a mobile telephone, by way of example, although the device is not limited to a mobile telephone and may just as well be a personal computer or a PDA (Personal Digital Assistant).

The web server 10 and file server 11 each include their own CPU, memory, hard-disk drive, hard disk, communication device, keyboard, mouse and display unit, etc. Programs for controlling operations described later have been installed in the web server 10 and file server 11. As will be described later, XML (Extensible Markup Language) data, crawler script, a template and script for general use, which are necessary in order to generate data for displaying a web page on the web server 10 in accordance with a request from the terminal device 1, have been stored in the file server 11.

In this embodiment, the terminal device 1 requests the web server 10 for a multimedia web page that includes content controlled by software (e.g., so-called “flash” software) that is for creating web content by combining images and audio, etc. In accordance with the request from the terminal device 1, data and files that have been stored in the file server 11 are read out. Using the read data and files, the web server 10 creates data that will be transmitted to the terminal device 1.

In particular, this embodiment is such that if the request from the terminal device 1 is one based upon a crawler, a multimedia web page that includes content controlled by software that is for creating web content by combining images and audio, etc., is converted by the web server 10 to a description based upon HTML. The web page data that has been converted to the HTML-based description is transmitted from the web server 10 to the terminal device 1. If a request from the terminal device 1 is not one based upon a crawler, then the data representing the web page that includes content represented by software for creating web content by combining images and audio, etc., is transmitted from the web server 10 to the terminal device 1 without being converted to a description based upon HTML.

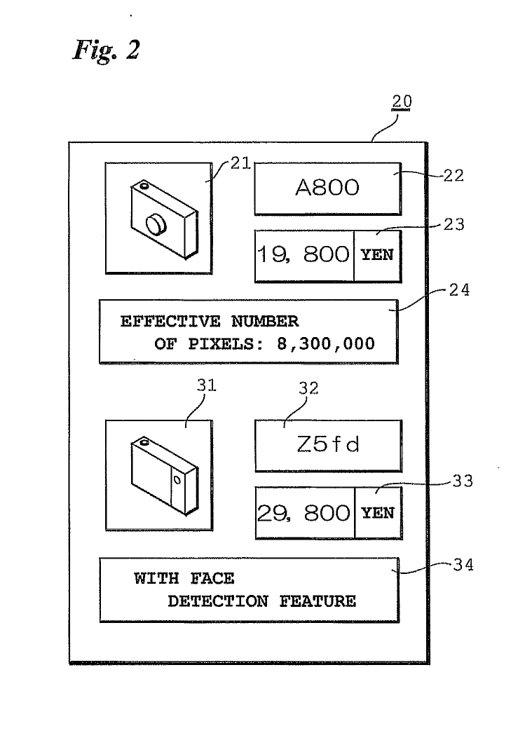

FIG. 2 illustrates an example of a multimedia web page requested by the terminal device 1.

Here a web page 20 introduces merchandise and specifically introduces products of two types. The top of the web page 20 is a portion that introduces a first product, and the bottom of the web page 20 introduces a second product.

A first product image display area 21 is formed at the upper left of the web page 20. The first product image display area 21 displays the image of the first product. A first name display area 22 and a first price display area 23 are displayed to the right of the first product image display area 21. The name of the first product is displayed in the first name display area 22, and the price for the first product is displayed in the first price display area 23. A first comment display area 24 is displayed below the first product image display area 21 and first price display area 23. A comment regarding the first product is displayed in the first comment display area 24.

A second product image display area 31 is displayed on the left side of the web page 20 at the central portion thereof. A second name display area 32 and a second price display area 33 are displayed to the right of the second product image display area 31. A second comment display area 34 is displayed below the second product image display area 31 and second price display area 33. The second product, the name of the second product, the price for the second product and a comment regarding the second product are displayed in the areas 31, 32, 33 and 34, respectively.

As mentioned above, if, in a case where the request for the web page 20 is not one that is based upon a crawler, content controlled by software for creating web content by combining images and audio, etc., is displayed in the first product image display area 21, first comment display area 24, second product image display area 31 and second comment display area 34, then the content (images of the products and the respective comments) displayed in the areas 21, 24, 31 and 34 is displayed so as to move on the display screen in accordance with this software.

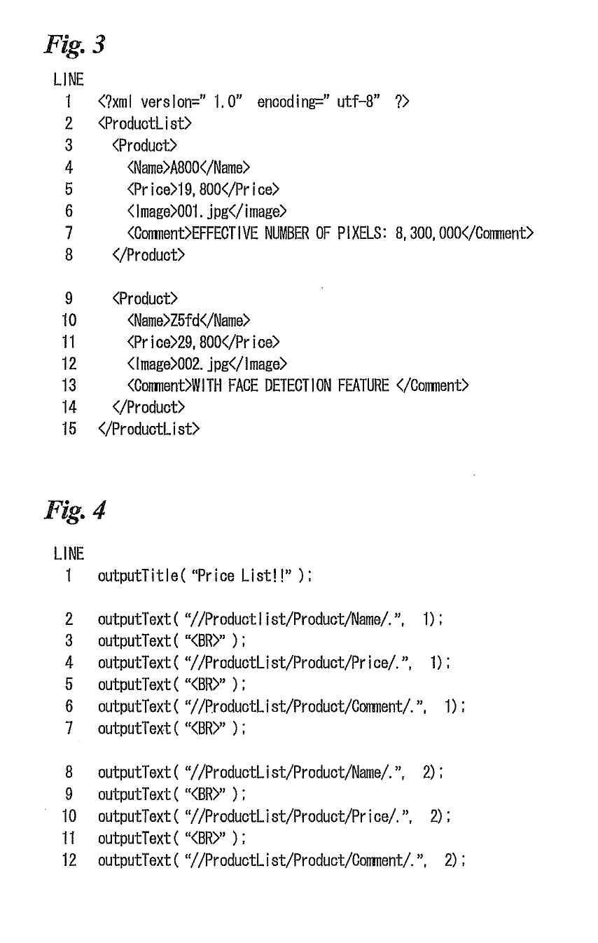

FIGS. 3 to 7 illustrate data and files, etc., that have been generated and stored in the file server 11. The web page 20 shown in FIG. 2 can be displayed by these data and files, etc. Line numbers have been added to the data to make it easier to understand a designation of description locations.

FIG. 3 illustrates an example of XML data.

Line 1 indicates that the data is XML data. Lines 2 to 15 indicate the details of the products displayed on the web page 20. Lines 2 to 8 indicate the details of the first product, and lines 9 to 14 indicate the nature of the second product. Lines 4, 5, 6 and 7 indicate the name of the first product, the price of the first product, the file name of the image of the first product and the comments regarding the first product, respectively. Similarly, Lines 10, 11, 12 and 13 indicate the name of the second product, the price of the second product, the file name of the image of the second product and the comments regarding the second product, respectively.

FIG. 4 illustrates an example of script for a crawler.

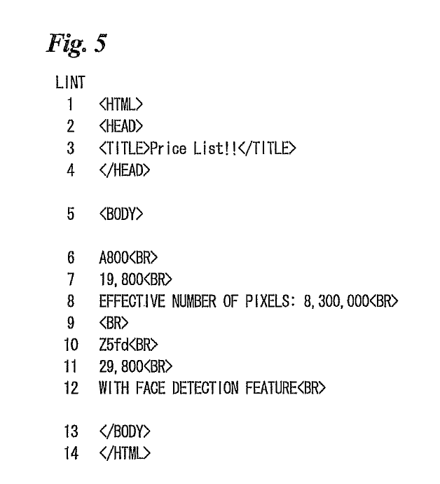

Crawler script converts the XML data of FIG. 3 to HTML data shown in FIG. 5.

Line 1 causes the title of the web page to be output as a description that is based upon HTML. Lines 2, 4, 6, 8, 10 and 12 are for designating the applicable locations of the respective items of XML data and have been described by a method, which is referred to as “Xpointer”, in the manner “//ProductList/Product/Name/”. The next argument 1 or 2 of Xpointer corresponds to the number (two) of products included in the XML data. The argument 1 corresponds to the first product, and the argument 2 corresponds to the second product. Lines 3, 5, 7, 9, 11 each output a BR tag to the HTML data.

FIG. 5 illustrates an example of the HTML data.

Lines 1 and 14 indicate the beginning and end, respectively of HTML data. Lines 2 and 3 indicate a header, in which Line 3 indicates the title. Lines 5 to 13 comprise body, in which Lines 6, 7 and 8 indicate the product name of the first product, the price of the first product and the comments regarding the first product, respectively. Line 9 indicates start of a new line. Lines 10, 11 and 12 indicate the product name of the second product, the price of the second product and the comments regarding the second product, respectively.

HTML data from Lines 1 to 5 shown in FIG. 5 is output by Line 1 shown in FIG. 4 by using the XML data shown in FIG. 3 and the crawler script shown in FIG. 4. Line 3 shown in FIG. 3 becomes Line 6 shown in FIG. 5 owing to Line 2 of FIG. 4. The BR tag on Line 6 of FIG. 5 is output by Line 3 of FIG. 4. It will be understood that with regard also to the other lines shown in FIG. 5, the XML data shown in FIG. 3 is converted to the HTML data shown in FIG. 5 using the crawler script shown in FIG. 4. The web page that includes the product names, prices and comments can be displayed by this HTML data.

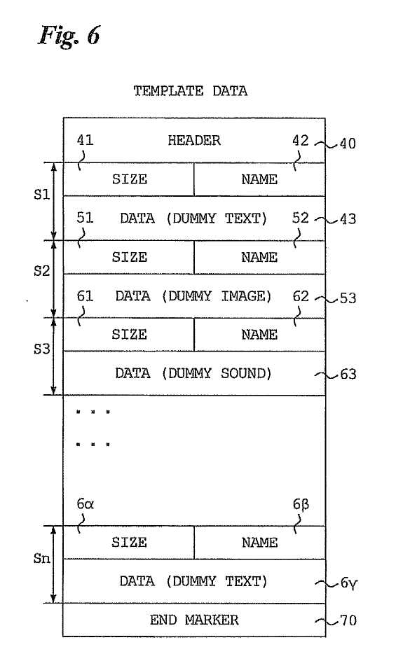

FIG. 6 illustrates the data structure (file structure) of a template.

This template is for generating a web page, which includes content controlled by software for creating web content by combining images and audio, etc., from XML data.

A header area 40 is formed at the beginning of the template and an end marker area 70 is formed at the end of the template. A number of segments S1 to Sn are formed between the header area 40 and the end marker area 70. The segments S1 to Sn include size areas 41, 51, 61, 6α, respectively, name areas 42, 52, 62, 6β, respectively, and data areas 43, 53, 63, 6γ, respectively. Data indicating segment size (amount of data) is stored in the size areas 41, 51, 61, 6α. Names specifying the segments are stored in the name areas 42, 52, 62, 6β. Dummy data such as image data, sound data and text data, etc., is stored in the data areas 43, 53, 63, 6γ.

For example, dummy text data is stored in the data area 43 of segment S1. Data representing a name “name1” is stored in the name area 42 in order to specify this dummy text data. Similarly, dummy image data is stored in the data area 53 of segment S2. Data representing a name “image1” is stored in the name area 52 in order to specify this dummy image data. Storage of data is similar for the other segments as well.

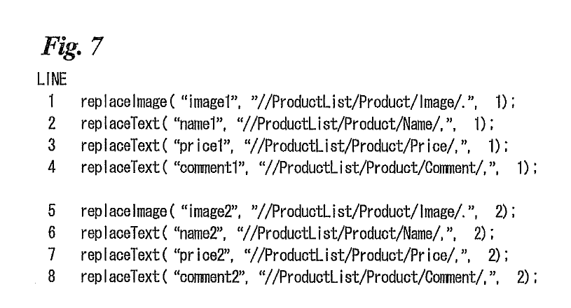

FIG. 7 is an example of script for general use.

The general-use script applies the XML data of FIG. 3 to each segment of the template shown in FIG. 6.

Line 1 instructs that the image data representing the first product image shown in FIG. 3 is to be stored in place of the dummy image data in the data area 53 of segment S2 having the name “image1”. Similarly, Line 2 instructs that the data representing the name of the first product shown in FIG. 3 is to be stored in the data area 43 of segment S1 having the name “name1”. Line 3 instructs that the data representing the price of the first product shown in FIG. 3 is to be stored in the data area of the segment having the name “price1”. Line 4 instructs that the data representing the comment regarding the first product shown in FIG. 3 is to be stored in the data area of the segment having the name “comment1”.

In a manner similar to Lines 1 to 4, Lines 5 to 8 instruct that the data representing the product image, name, price and comment regarding the second product is to be stored in the corresponding areas of the template.

Storing each of the items of data such as image data specified by the XML data of FIG. 3 in the template of FIG. 6 in accordance with the general-use script shown in FIG. 7 makes it possible to display a multimedia web page that includes content controlled by software for creating web content by combining images and audio, etc., as illustrated in FIG. 3.

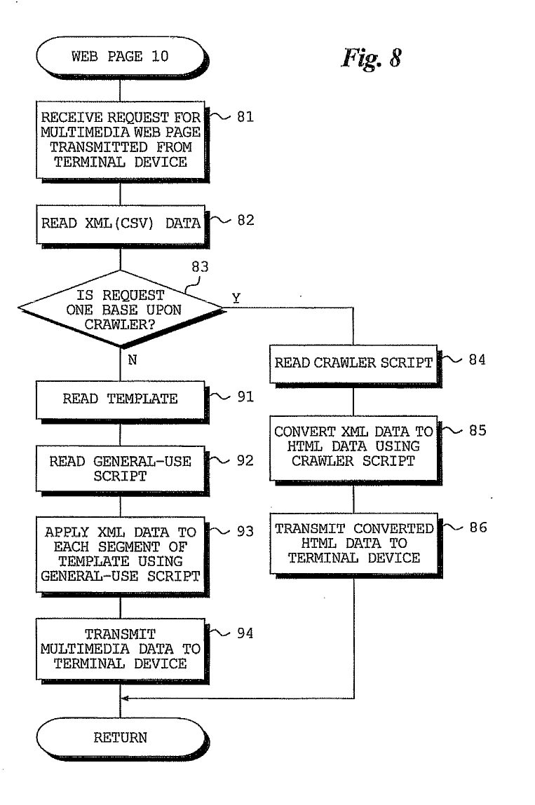

FIG. 8 is a flowchart illustrating processing executed by the web server 10.

The terminal device 1 requests the web server 10 for a multimedia web page. For example, the terminal device 1 requests a web page having the following URL (Uniform Resource Locator): http://server/product.swf. Upon receiving the request data transmitted from the terminal device (step 81), the web server 10 reads XML data [which may be CSV (Comma-Separated Values) data] (see FIG. 3), which is for displaying the requested multimedia web page, from the file server 11 (step 82).

Next, it is determined whether the request is one based upon a crawler (step 83). For example, if a crawler is that of Company A, then UserAgent included in the request data will be AAAbot/2.1 (+http://www.AAA.com/bot.html), and if a crawler is that of Company B, then UserAgent included in the request data will be CCC/5.0 (compatible;BBB!Slurp;http: //help.BBB.com/help/us/aseach/slurp). Accordingly, whether the request is one based upon a crawler can be determined based upon whether these UserAgents are included in the request data.

If the request is one based upon a crawler (“YES” at step 83), then crawler script (see FIG. 4) that is in accordance with the request is read from the file server 11 (step 84). HTML data that is the result of converting the read XML data to HTML data (see FIG. 5) using the crawler script in the manner described above is transmitted from the web server 10 to the mobile terminal 1 (steps 85 and 86). The crawler cannot interpret the multimedia web page but it can interpret data if the data is HTML data. In this embodiment, HTML data that is the result of a conversion is transmitted when a multimedia web page is requested. The crawler, therefore, is capable of interpreting the content of the web page.

If the request is not one that is based upon a crawler (“NO” at step 83), then the template (see FIG. 6) is read from the file server 11 (step 91). Next, the general-use script (see FIG. 7) is read from the file server 11 (step 92). By applying the read XML data to each segment of the template using the general-use script, as described above, the data of the multimedia page is generated (step 93). The generated data of the multimedia web page is transmitted from the web server 10 to the terminal device 1 (step 94).

As many apparently widely different embodiments of the present invention can be made without departing from the spirit and scope thereof, it is to be understood that the invention is not limited to the specific embodiments thereof except as defined in the appended claims.

1. A web page data transmitting apparatus comprising:
a web page request receiving device for receiving a request for a web page that includes content controlled by software for creating web content by combining images and audio;
a determination device for determining whether transmission of the request received by said web page request receiving device is based upon a crawler;
a converting device, responsive to a determination by said determination device that the transmission of the request is based upon a crawler, for converting a description of the web page specified by the request received by said web page request receiving device from one controlled by the software for creating the web content to one based upon HTML; and
a transmitting device for transmitting data, which represents the web page converted by said converting device to the description that is based upon HTML, to a terminal device that issued the request.

2. A method of controlling operation of a web page data transmitting apparatus, comprising the steps of:
utilizing at least one computer processor in the apparatus to perform the following:
receive a request for a web page that includes content controlled by software for creating web content by combining images and audio;
determine whether transmission of the request received by the web page request receiving device is based upon a crawler, and;
in response to a determination that the transmission of the request is based upon a crawler, convert a description of the web page specified by the received request from one controlled by the software for creating the web content to one based upon HTML; and
transmitting data, which represents the web page converted to the description that is based upon HTML, from the apparatus to a terminal device that issued the request.

3. A computer program embodied on a computer-readable storage medium comprising instructions which, when executed by at least one computer processor, controls operation of a web page data transmitting apparatus so as to cause the apparatus to:
receive a request for a web page that includes content controlled by software for creating web content by combining images and audio;
determine whether transmission of the request received is based upon a crawler;
in response to a determination that the transmission of the request is based upon a crawler, convert a description of the web page specified by the received request from one controlled by the software for creating the web content to one based upon HTML; and
transmit data, which represents the web page converted to the description that is based upon HTML, to a terminal device that issued the request.
